(19) United States
(12) Patent Application Publication
(10) Pub. No.: US 2025/0374125 A1
(43) Pub. Date: Dec. 4, 2025

(54) APPARATUS, METHOD, AND COMPUTER PROGRAM

(71) Applicant: Nokia Technologies Oy, Espoo (FI)

(72) Inventors: Devaki CHANDRAMOULI, Dallas, TX (US); Deepa MALAPATI RAVINDRAIAH, Bangalore (IN); Ece GOSHI, Munich (DE)

(21) Appl. No.: 19/101,360

(22) PCT Filed: Aug. 3, 2023
(86) PCT No.: PCT/IB2023/057875

§ 371 Date: Feb. 5, 2025

(30) Foreign Application Priority Data
Aug. 5, 2022 (IN) 202211044817

(51) Int. Cl. H04W 28/26; H04W 72/21; H04W 76/38

(52) U.S. Cl. CPC H04W 28/26; H04W 72/21; H04W 76/38

(57) ABSTRACT

There is provided a method, apparatus, and computer program for an application function, that causes the application function to signal, to a first network function, an indication of a first number of data flows and/or of user equipment whose communications are to be jointly handled, an identifier of said first number of data flows that are to be jointly handled, an indicator that joint handling is to be performed for the first number of data flows and/or of user equipment, and said first number of data flows and/or user equipment for which resources are to be configured.

### CROSS-REFERENCE TO RELATED APPLICATIONS

This application claims the benefit of priority of Indian Provisional Patent Application No. 202211044817 filed Aug. 5, 2022, the contents of which are hereby incorporated by reference as if reproduced in their entirety.

### FIELD OF THE DISCLOSURE

The examples described herein generally relate to apparatus, methods, and computer programs, and more particularly (but not exclusively) to apparatus, methods and computer programs for network apparatuses.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to a first aspect, there is provided a method for a radio access network entity, the method comprising: receiving, from a network function, an indication of a first number of data flows and/or of user equipment whose communications are to be jointly handled, an identifier of said first number of data flows that are to be jointly handled, an indicator that joint handling is to be performed for the first number of data flows and/or of user equipment, and a subset of said first number of data flows and/or user equipment for which resources are to be configured; determining whether the radio access network entity is able to reserve enough resources for jointly handling at least said subset of said first number of data flows and/or of user equipment; and signalling a result of said determination to the network function.

The result of said determination may be that resources can be reserved in respect of all of said first number of data flows and/or user equipment, and the method may comprise: configuring a first portion of said resources that are comprised in said subset; reserving a second portion of said resources in respect of all of the data flows and/or user equipment of said first number data flows and/or user equipment that are not comprised in said subset; starting a timer when reserving said second portion of said resources; and releasing any of said reserved resources that have not been configured at a user equipment at an expiry of said timer.

The result of said determination may be that resources can be reserved in respect of only the subset, and the method may comprise: reserving said resources in respect of at least the subset of the said subset of data flows and/or user equipment.

The method may comprise starting a timer when reserving said resources; and releasing any of said reserved resources that have not been configured at a user equipment at an expiry of said timer.

The method may comprise subsequent to said signalling the network function: receiving, from the network function, an instruction to release said reserved resources; and releasing said reserved resources in response to receiving said instruction.

The result of said determination may be that no resources may be reserved in respect of any of said data flows and/or user equipment.

According to a second aspect, there is provided a method for a first network function, the method comprising: receiving, from a second network function, a first indication of a first number of data flows and/or of user equipment whose communications are to be jointly handled, an identifier of said first number of data flows that are to be jointly handled, an indicator that joint handling is to be performed for the first number of data flows and/or of user equipment, and a subset of said first number of data flows and/or user equipment for which resources are to be configured; signalling said first indication to at least one of a radio access network entity and/or a third network function; and receiving, from the at least one of a radio access network entity and/or a third network function, a second indication of whether the radio access network entity is able to reserve enough resources for jointly handling at least the said subset.

The second network function may be at least one of: an application function; a network exposure function; a policy control function; and/or a session management function.

The first network function may be at least one of: a network exposure function; a policy control function; a session management function; and/or an access and mobility function.

The third network function may be at least one of: a policy control function; a session management function; an access and mobility function, and/or an application function.

The second indication may indicate that resources are configured in respect of a subset of said data flow(s) and/or user equipment and can be reserved in respect of a remaining subset of said data flows and/or user equipment of the first set, and the method may comprise signalling said second indication to the second network function.

The second indication may indicate that resources can be reserved in respect of a subset of said data flows and/or user equipment, the method may comprise signalling said second indication to the second network function.

The method may comprise signalling, to the at least one of a radio access network entity and/or a third network function, an instruction to configure the reserved resources for at least the subset and/or all of the data flows and/or user equipment of said first number data flows and/or user equipment that are not comprised in said subset.

The method may comprise signalling, to the at least one of a radio access network entity and/or a third network function, an instruction to release said reserved resources.

The second indication may indicate that resources cannot be reserved in respect of any of said data flows and/or user equipment, and the method may comprise signalling said second indication to the second network function.

According to a third aspect, there is provided a method for an application function, the method comprising signalling, to a first network function, an indication of a first number of data flows and/or of user equipment whose communications are to be jointly handled, an identifier of said first number of data flows that are to be jointly handled, an indicator that joint handling is to be performed for the first number of data flows and/or of user equipment, and said first number of data flows and/or user equipment for which resources are to be configured.

According to a fourth aspect, there is provided an apparatus for a radio access network entity, the apparatus comprising means for: receiving, from a network function, an indication of a first number of data flows and/or of user equipment whose communications are to be jointly handled, an identifier of said first number of data flows that are to be jointly handled, an indicator that joint handling is to be performed for the first number of data flows and/or of user equipment, and a subset of said first number of data flows and/or user equipment for which resources are to be configured; determining whether the radio access network entity is able to reserve enough resources for jointly handling at least said subset of said first number of data flows and/or of user equipment; and signalling a result of said determination to the network function.

The result of said determination may be that resources can be reserved in respect of all of said first number of data flows and/or user equipment, and the apparatus may comprise means for: configuring a first portion of said resources that are comprised in said subset; reserving a second portion of said resources in respect of all of the data flows and/or user equipment of said first number data flows and/or user equipment that are not comprised in said subset; starting a timer when reserving said second portion of said resources; and releasing any of said reserved resources that have not been configured at a user equipment at an expiry of said timer.

The result of said determination may be that resources can be reserved in respect of only the subset, and the apparatus may comprise means for: reserving said resources in respect of at least the subset of the said subset of data flows and/or user equipment.

The apparatus may comprise means for starting a timer when reserving said resources; and releasing any of said reserved resources that have not been configured at a user equipment at an expiry of said timer.

The apparatus may comprise means for, subsequent to said signalling the network function: receiving, from the network function, an instruction to release said reserved resources; and releasing said reserved resources in response to receiving said instruction.

The result of said determination may be that no resources may be reserved in respect of any of said data flows and/or user equipment.

According to a fifth aspect, there is provided an apparatus for a first network function, the apparatus comprising means for: receiving, from a second network function, a first indication of a first number of data flows and/or of user equipment whose communications are to be jointly handled, an identifier of said first number of data flows that are to be jointly handled, an indicator that joint handling is to be performed for the first number of data flows and/or of user equipment, and a subset of said first number of data flows and/or user equipment for which resources are to be configured; signalling said first indication to at least one of a radio access network entity and/or a third network function; and receiving, from the at least one of a radio access network entity and/or a third network function, a second indication of whether the radio access network entity is able to reserve enough resources for jointly handling at least the said subset.

The second network function may be at least one of: an application function; a network exposure function; a policy control function; and/or a session management function.

The first network function may be at least one of: a network exposure function; a policy control function; a session management function; and/or an access and mobility function.

The third network function may be at least one of: a policy control function; a session management function; an access and mobility function, and/or an application function.

The second indication may indicate that resources are configured in respect of a subset of said data flow(s) and/or user equipment and can be reserved in respect of a remaining subset of said data flows and/or user equipment of the first set, and the apparatus may comprise means for signalling said second indication to the second network function.

The second indication may indicate that resources can be reserved in respect of a subset of said data flows and/or user equipment, the apparatus may comprise means for signalling said second indication to the second network function.

The apparatus may comprise means for signalling, to the at least one of a radio access network entity and/or a third network function, an instruction to configure the reserved resources for at least the subset and/or all of the data flows and/or user equipment of said first number data flows and/or user equipment that are not comprised in said subset.

The apparatus may comprise means for signalling, to the at least one of a radio access network entity and/or a third network function, an instruction to release said reserved resources.

The second indication may indicate that resources cannot be reserved in respect of any of said data flows and/or user equipment, and the apparatus may comprise means for signalling said second indication to the second network function.

According to a sixth aspect, there is provided an apparatus for an application function, the apparatus may comprise means for signalling, to a first network function, an indication of a first number of data flows and/or of user equipment whose communications are to be jointly handled, an identifier of said first number of data flows that are to be jointly handled, an indicator that joint handling is to be performed for the first number of data flows and/or of user equipment, and said first number of data flows and/or user equipment for which resources are to be configured.

According to a seventh aspect, there is provided an apparatus for a radio access network entity, the apparatus comprising: at least one processor; and at least one memory comprising code that, when executed by the at least one processor, causes the apparatus to: receive, from a network function, an indication of a first number of data flows and/or of user equipment whose communications are to be jointly handled, an identifier of said first number of data flows that are to be jointly handled, an indicator that joint handling is to be performed for the first number of data flows and/or of user equipment, and a subset of said first number of data flows and/or user equipment for which resources are to be configured; determine whether the radio access network entity is able to reserve enough resources for jointly handling at least said subset of said first number of data flows and/or of user equipment; and signal a result of said determination to the network function.

The result of said determination may be that resources can be reserved in respect of all of said first number of data flows and/or user equipment, and the apparatus may be caused to: configure a first portion of said resources that are comprised in said subset; reserve a second portion of said resources in respect of all of the data flows and/or user equipment of said first number data flows and/or user equipment that are not comprised in said subset; start a timer when reserving said second portion of said resources; and release any of said reserved resources that have not been configured at a user equipment at an expiry of said timer.

The result of said determination may be that resources can be reserved in respect of only the subset, and the apparatus may be caused to: reserve said resources in respect of at least the subset of the said subset of data flows and/or user equipment.

The apparatus may be caused to start a timer when reserving said resources; and release any of said reserved resources that have not been configured at a user equipment at an expiry of said timer.

The apparatus may be caused to, subsequent to said signalling the network function: receive, from the network function, an instruction to release said reserved resources; and release said reserved resources in response to receiving said instruction.

The result of said determination may be that no resources may be reserved in respect of any of said data flows and/or user equipment.

According to an eighth aspect, there is provided an apparatus for a first network function, the apparatus comprising: at least one processor; and at least one memory comprising code that, when executed by the at least one processor, causes the apparatus to: receive, from a second network function, a first indication of a first number of data flows and/or of user equipment whose communications are to be jointly handled, an identifier of said first number of data flows that are to be jointly handled, an indicator that joint handling is to be performed for the first number of data flows and/or of user equipment, and a subset of said first number of data flows and/or user equipment for which resources are to be configured; signal said first indication to at least one of a radio access network entity and/or a third network function; and receive, from the at least one of a radio access network entity and/or a third network function, a second indication of whether the radio access network entity is able to reserve enough resources for jointly handling at least the said subset.

The second network function may be at least one of: an application function; a network exposure function; a policy control function; and/or a session management function.

The first network function may be at least one of: a network exposure function; a policy control function; a session management function; and/or an access and mobility function.

The third network function may be at least one of: a policy control function; a session management function; an access and mobility function, and/or an application function.

The second indication may indicate that resources are configured in respect of a subset of said data flow(s) and/or user equipment and can be reserved in respect of a remaining subset of said data flows and/or user equipment of the first set, and the apparatus may be caused to signal said second indication to the second network function.

The second indication may indicate that resources can be reserved in respect of a subset of said data flows and/or user equipment, the apparatus may be caused to signal said second indication to the second network function.

The apparatus may be caused to signal, to the at least one of a radio access network entity and/or a third network function, an instruction to configure the reserved resources for at least the subset and/or all of the data flows and/or user equipment of said first number data flows and/or user equipment that are not comprised in said subset.

The apparatus may be caused to signal, to the at least one of a radio access network entity and/or a third network function, an instruction to release said reserved resources.

The second indication may indicate that resources cannot be reserved in respect of any of said data flows and/or user equipment, and the apparatus may be caused to signal said second indication to the second network function.

According to a ninth aspect, there is provided an apparatus for an application function, the apparatus may comprise: at least one processor; and at least one memory comprising code that, when executed by the at least one processor, causes the apparatus to: signal, to a first network function, an indication of a first number of data flows and/or of user equipment whose communications are to be jointly handled, an identifier of said first number of data flows that are to be jointly handled, an indicator that joint handling is to be performed for the first number of data flows and/or of user equipment, and said first number of data flows and/or user equipment for which resources are to be configured.

According to a tenth aspect, there is provided an apparatus for a radio access network entity, the apparatus comprising: receiving circuitry for receiving, from a network function, an indication of a first number of data flows and/or of user equipment whose communications are to be jointly handled, an identifier of said first number of data flows that are to be jointly handled, an indicator that joint handling is to be performed for the first number of data flows and/or of user equipment, and a subset of said first number of data flows and/or user equipment for which resources are to be configured; determining circuitry for determining whether the radio access network entity is able to reserve enough resources for jointly handling at least said subset of said first number of data flows and/or of user equipment; and signalling circuitry for signalling a result of said determination to the network function.

The result of said determination may be that resources can be reserved in respect of all of said first number of data flows and/or user equipment, and the apparatus may comprise: configuring circuitry for configuring a first portion of said resources that are comprised in said subset; reserving a second portion of said resources in respect of all of the data flows and/or user equipment of said first number data flows and/or user equipment that are not comprised in said subset; starting circuitry for starting a timer when reserving said second portion of said resources; and releasing circuitry for releasing any of said reserved resources that have not been configured at a user equipment at an expiry of said timer.

The result of said determination may be that resources can be reserved in respect of only the subset, and the apparatus may comprise: reserving circuitry for reserving said resources in respect of at least the subset of the said subset of data flows and/or user equipment.

The apparatus may comprise starting circuitry for starting a timer when reserving said resources; and releasing circuitry for releasing any of said reserved resources that have not been configured at a user equipment at an expiry of said timer.

The apparatus may comprise, subsequent to said signalling the network function: receiving circuitry for receiving, from the network function, an instruction to release said reserved resources; and releasing circuitry for releasing said reserved resources in response to receiving said instruction.

The result of said determination may be that no resources may be reserved in respect of any of said data flows and/or user equipment.

According to an eleventh aspect, there is provided an apparatus for a first network function, the apparatus comprising: receiving circuitry for receiving, from a second network function, a first indication of a first number of data flows and/or of user equipment whose communications are to be jointly handled, an identifier of said first number of data flows that are to be jointly handled, an indicator that joint handling is to be performed for the first number of data flows and/or of user equipment, and a subset of said first number of data flows and/or user equipment for which resources are to be configured; signalling circuitry for signalling said first indication to at least one of a radio access network entity and/or a third network function; and receiving circuitry for receiving, from the at least one of a radio access network entity and/or a third network function, a second indication of whether the radio access network entity is able to reserve enough resources for jointly handling at least the said subset.

The second network function may be at least one of: an application function; a network exposure function; a policy control function; and/or a session management function.

The first network function may be at least one of: a network exposure function; a policy control function; a session management function; and/or an access and mobility function.

The third network function may be at least one of: a policy control function; a session management function; an access and mobility function, and/or an application function.

The second indication may indicate that resources are configured in respect of a subset of said data flow(s) and/or user equipment and can be reserved in respect of a remaining subset of said data flows and/or user equipment of the first set, and the apparatus may comprise signalling circuitry for signalling said second indication to the second network function.

The second indication may indicate that resources can be reserved in respect of a subset of said data flows and/or user equipment, the apparatus may comprise signalling circuitry for signalling said second indication to the second network function.

The apparatus may comprise signalling circuitry for signalling, to the at least one of a radio access network entity and/or a third network function, an instruction to configure the reserved resources for at least the subset and/or all of the data flows and/or user equipment of said first number data flows and/or user equipment that are not comprised in said subset.

The apparatus may comprise signalling circuitry for signalling, to the at least one of a radio access network entity and/or a third network function, an instruction to release said reserved resources.

The second indication may indicate that resources cannot be reserved in respect of any of said data flows and/or user equipment, and the apparatus may comprise signalling circuitry for signalling said second indication to the second network function.

According to a twelfth aspect, there is provided an apparatus for an application function, the apparatus may comprise signalling circuitry for signalling, to a first network function, an indication of a first number of data flows and/or of user equipment whose communications are to be jointly handled, an identifier of said first number of data flows that are to be jointly handled, an indicator that joint handling is to be performed for the first number of data flows and/or of user equipment, and said first number of data flows and/or user equipment for which resources are to be configured.

According to a thirteenth aspect, there is provided non-transitory computer readable medium comprising program instructions for causing an apparatus for a radio access network entity to perform at least the following: receive, from a network function, an indication of a first number of data flows and/or of user equipment whose communications are to be jointly handled, an identifier of said first number of data flows that are to be jointly handled, an indicator that joint handling is to be performed for the first number of data flows and/or of user equipment, and a subset of said first number of data flows and/or user equipment for which resources are to be configured; determine whether the radio access network entity is able to reserve enough resources for jointly handling at least said subset of said first number of data flows and/or of user equipment; and signal a result of said determination to the network function.

The result of said determination may be that resources can be reserved in respect of all of said first number of data flows and/or user equipment, and the apparatus may be caused to: configure a first portion of said resources that are comprised in said subset; reserve a second portion of said resources in respect of all of the data flows and/or user equipment of said first number data flows and/or user equipment that are not comprised in said subset; start a timer when reserving said second portion of said resources; and release any of said reserved resources that have not been configured at a user equipment at an expiry of said timer.

The result of said determination may be that resources can be reserved in respect of only the subset, and the apparatus may be caused to: reserve said resources in respect of at least the subset of the said subset of data flows and/or user equipment.

The apparatus may be caused to start a timer when reserving said resources; and release any of said reserved resources that have not been configured at a user equipment at an expiry of said timer.

The apparatus may be caused to, subsequent to said signalling the network function: receive, from the network function, an instruction to release said reserved resources; and release said reserved resources in response to receiving said instruction.

The result of said determination may be that no resources may be reserved in respect of any of said data flows and/or user equipment.

According to a fourteenth aspect, there is provided non-transitory computer readable medium comprising program instructions for causing an apparatus for a first network function to perform at least the following: receive, from a second network function, a first indication of a first number of data flows and/or of user equipment whose communications are to be jointly handled, an identifier of said first number of data flows that are to be jointly handled, an indicator that joint handling is to be performed for the first number of data flows and/or of user equipment, and a subset of said first number of data flows and/or user equipment for which resources are to be configured; signal said first indication to at least one of a radio access network entity and/or a third network function; and receive, from the at least one of a radio access network entity and/or a third network function, a second indication of whether the radio access network entity is able to reserve enough resources for jointly handling at least the said subset.

The second network function may be at least one of: an application function; a network exposure function; a policy control function; and/or a session management function.

The first network function may be at least one of: a network exposure function; a policy control function; a session management function; and/or an access and mobility function.

The third network function may be at least one of: a policy control function; a session management function; an access and mobility function, and/or an application function.

The second indication may indicate that resources are configured in respect of a subset of said data flow(s) and/or user equipment and can be reserved in respect of a remaining subset of said data flows and/or user equipment of the first set, and the apparatus may be caused to signal said second indication to the second network function.

The second indication may indicate that resources can be reserved in respect of a subset of said data flows and/or user equipment, the apparatus may be caused to signal said second indication to the second network function.

The apparatus may be caused to signal, to the at least one of a radio access network entity and/or a third network function, an instruction to configure the reserved resources for at least the subset and/or all of the data flows and/or user equipment of said first number data flows and/or user equipment that are not comprised in said subset.

The apparatus may be caused to signal, to the at least one of a radio access network entity and/or a third network function, an instruction to release said reserved resources.

The second indication may indicate that resources cannot be reserved in respect of any of said data flows and/or user equipment, and the apparatus may be caused to signal said second indication to the second network function.

According to a fifteenth aspect, there is provided non-transitory computer readable medium comprising program instructions for causing an apparatus for an application function to perform at least the following: signal, to a first network function, an indication of a first number of data flows and/or of user equipment whose communications are to be jointly handled, an identifier of said first number of data flows that are to be jointly handled, an indicator that joint handling is to be performed for the first number of data flows and/or of user equipment, and said first number of data flows and/or user equipment for which resources are to be configured.

According to a sixteenth aspect, there is provided a computer program product stored on a medium that may cause an apparatus to perform any method as described herein.

According to a seventeenth aspect, there is provided an electronic device that may comprise apparatus as described herein.

According to an eighteenth aspect, there is provided a chipset that may comprise an apparatus as described herein.

### BRIEF DESCRIPTION OF FIGURES

Some examples, will now be described, merely by way of illustration only, with reference to the accompanying drawings in which:

FIGS. 1A and 1B show a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 shows a schematic representation of a network;

FIGS. 6 to 8 illustrate example signalling that may be performed between apparatus described herein; and

FIGS. 9 to 11 illustrate example operations that may be performed by apparatus described herein.

### DETAILED DESCRIPTION

In the following description of examples, certain aspects are explained with reference to mobile communication devices capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems (for example, current 6G proposals).

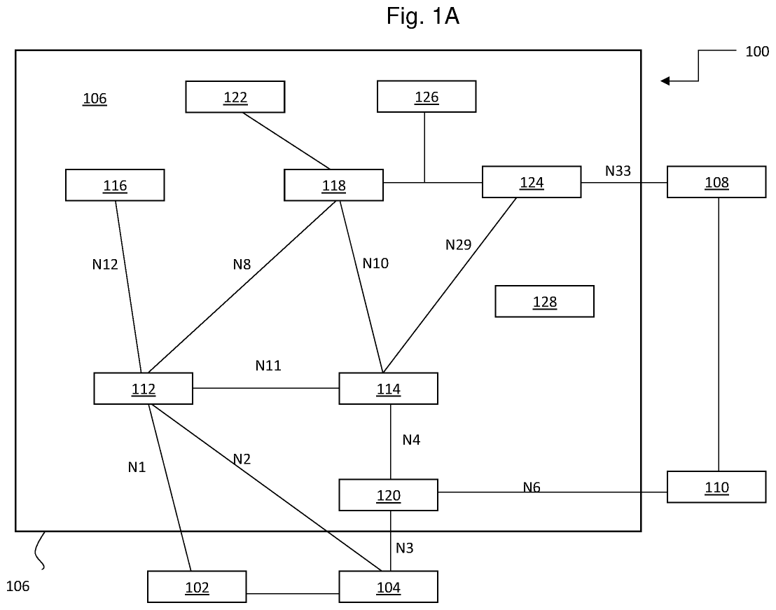

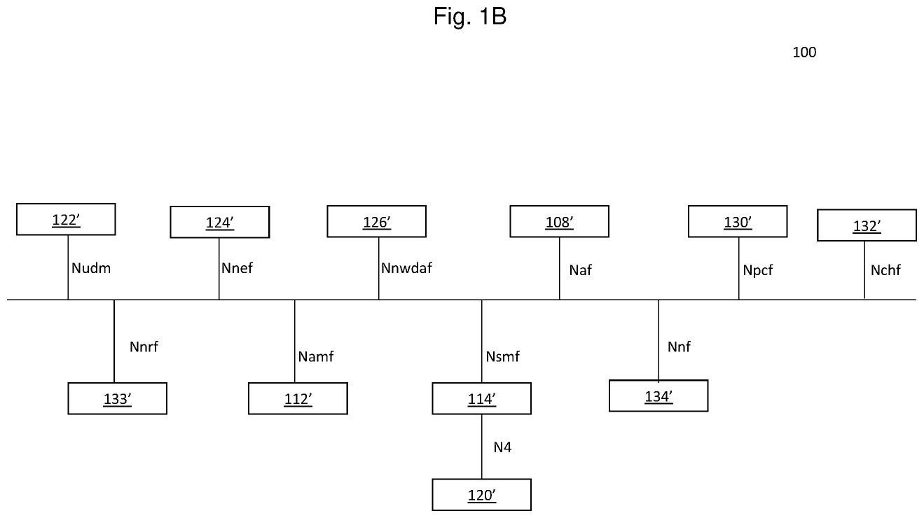

Before describing in detail the examples, certain general principles of a 5G wireless communication system are briefly explained with reference to FIGS. 1A and 1B.

FIG. 1A shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes.

The 5GC 106 may comprise one or more Access and Mobility Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. The role of an NEF is to provide secure exposure of network services (e.g. voice, data connectivity, charging, subscriber data, and so forth) towards a 3rd party. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

The network may further comprise a management data analytics service (MDAS) producer or MDAS Management Service (MnS) producer. The MDAS MnS producer may provide data analytics in the management plane considering parameters including, for example, load level and/or resource utilization. For example, the MDAS MnS producer for a network function (NF) may collect the NF's load-related performance data, e.g., resource usage status of the NF. The analysis of the collected data may provide forecast of resource usage information in a predefined future time window. This analysis may also recommend appropriate actions e.g., scaling of resources, admission control, load balancing of traffic, and so forth.

FIG. 1B shows a schematic representation of a 5GC represented in current 3GPP specifications. It is understood that this architecture is intended to illustrate potential components that may be comprised in a core network, and the presently described principles are not limited to core networks comprising only the described components.

FIG. 1B shows a 5GC 106′ comprising a UPF 120′ connected to an SMF 114′ over an N4 interface. The SMF 114′ is connected to each of a UDM 122′, an NEF 124′, an NWDAF 126′, an AF 108′, a Policy Control Function (PCF) 130′, an AMF 112′, and a Charging function 132′ over an interconnect medium that also connects these network functions to each other. The 5G core 106′ further comprises a network repository function (NRF) 133′ and a network function 134′ that connect to the interconnect medium.

3GPP refers to a group of organizations that develop and release different standardized communication protocols. 3GPP develops and publishes documents pertaining to a system of “Releases” (e.g., Release 15, Release 16, and beyond).

To manage data traffic for a UE using multiple access concurrently, an operator can define policies to flexibly use multiple access for different data flows.

For 3GPP Release 18, 5G System (5GS) enhancements to support extended reality (XR) are being considered. At least two different key issues to be resolved have been identified. First, how multiple flows from an application for a single UE are to be coordinated. Second, how multiple flows from an application for multiple UEs are to be coordinated. These will be considered below. In the present instance, these multiple flows may be service flows, which describe and carry media data for one or more media types. From a network perspective, these multiple flows may be QoS (quality of service) flows that describe and carry media data with set quality of service parameters for one or more media types.

First, how multiple flows for a single UE are to be coordinated is considered.

Some advanced XR or media services may include multiple types of flows, e.g. video/audio stream, and may comprise haptic and/or sensor data for providing a more immersive experience to a user.

The application client(s) of the different types of data of one application may be located at one UE. In another case, there are multiple types of devices, e.g. VR glasses, gloves and other devices that support haptic and/or kinesthetic modalities. These multiple devices may connect (e.g., via a wireline connection) to a single UE that can access the 5GS.

The objective of this Key Issue is to study how to enhance 5GS to better support the coordinated delivery of application traffic streams that are related to each other and belong to a single UE.

In particular, this key issue may consider whether, and how, to enable, for a single UE, policy enhancements for delivering related tactile and multi-modal data (e.g. audio, video and haptic data related to a specific time) for an application to the user at a similar time. This may involve an element of Quality of Service (QOS) policy coordination.

This issue may further consider potential enhancements to policy control to support coordination handling at the application.

Further, this issue may further consider whether, and in which way, any interaction between an application function (AF) and a 5GS is performed for application synchronization and QoS policy coordination between multiple QoS flows of a single UE.

Second, how multiple flows for multiple UEs are to be coordinated is considered.

As above, the application client(s) of the different types of data of one application may be located at one UE. In another case, there are multiple types of devices, e.g. VR glasses, gloves and other devices that support haptic and/or kinesthetic modalities. These multiple devices may connect (e.g., via a wireline connection) to a single UE that can access the 5GS.

In more detail, a 5G system may be configured to support policies for flows associated with an application that are provided by at least one 3rd party (i.e., that are not provided by a network operator). A provided policy may comprise at least one of a plurality of different types of information. For example, the provided may comprise information relating to identifications of a set of UEs and/or data flows to which the policy relates, an expected QoS handling, and a definition of any triggering events that may cause the policy to be implemented. The policy may be used by a 3rd party application for coordination of the transmission of multiple UEs' flows (e.g. haptic, audio and video) of a multi-modal communication session.

This key issue is thus directed towards studying how to enable application synchronization and QoS policy coordination for Multi-modal Data flows among multiple UEs.

In particular, this second key issue may consider whether, and how to, enable for multiple UEs, deliver related tactile and multi-modal data (e.g., audio, video and haptic data related to a specific time) with an application to a user at a similar time. This may focus on policy control enhancements (e.g. QoS policy coordination).

This second key issue may further consider potential enhancements to policy control to support coordination handling at the application.

Finally, this second key issue may consider whether, and in which way, an interaction between an AF and the 5GS is needed for QoS policy coordination among multiple UEs.

Several ways of addressing at least one of the above identified issues have been proposed.

For example, one mechanism proposes to define an ability for a Radio Access Network (RAN) to group multiple flows together and to provide assistance information (based on information provided by the AF) so that the RAN knows the corresponding flows are grouped. This may be achieved by, for example, use of respective Flow Group identifiers for each group of multiple flows.

Another mechanism proposes to configure the RAN to perform admission control for the flows that belong to a given group of flows.

However, none of the proposed mechanisms resolve any logic for enforcement of admission control for a group of flows and/or of UE(s). For example, when a first UE is admitted to a group of flows while a second UE cannot be admitted to a group of flows, then RAN behaviour and/or network behaviour is not determined. This may result in out of sync playout between different devices receiving different flows.

To address at least one of the above-identified issues, the following proposes to indicate that certain flows are to be handled jointly, and to enable a RAN entity to determine whether or not it can reserve network resources (e.g., time and frequency resources) in respect of all of those resources.

In particular, there is provided an application function (AF) that is configured to provide flows and UEs that need synchronized delivery and/or joint treatment. Based on this, a number of Flows and UE(s) that are to be treated jointly can be determined by 5GS. For example, a number of flow(s) and/or UE(s) that are to be treated jointly may be requested by an application function, and interpreted by a network function associated with a 5GC (such as, for example, an NEF, a PCF, and/or an SMF).

Throughout the following, reference will be made to joint handling of flows and/or UEs. In the present context, “joint handling” refers to the network treating the jointly handled multiple flow(s) and/or UE(s) together. This means that, for example, when an event occurs that directly affects one of the flows within the multiple flows, the decision for a subsequent action is taken in consideration of all the flows, and the decision is applied to all the flows.

There is further provided a network exposure function (NEF) that is configured to forward the information related to a number of flows and UE(s) to a Policy Control Function (PCF), which may subsequently provide this information to a session management function (SMF) as part of policy information related to a session.

When the SMF subsequently requests resource allocation from a RAN for resource allocation for the first flow(s) for a given UE within the group, the SMF may provide this total number of Flows and/or UE(s) involved in this group along with the Flow Group ID and a joint admission indication. RAN may perform admission control considering all the Flows and/or UE(s) using this information.

When the RAN succeeds in performing admission control for the first flow and/or UE, and when the RAN has resources to admit the subsequent flows and/or UE(s) of the group, then the RAN can activate a user plane for the first UE/Flow and also reserve resources for anticipated subsequent flows and/or UE(s) of the group for a fixed duration. In the event that the anticipated subsequent flows and/or UE(s) resource request do not arrive within the fixed duration, then the RAN may release the resources to avoid resource wastage in the network. This release of resources may be performed by a control plane entity in the RAN that is configured to perform admission control procedures within the RAN.

When the RAN succeeds in performing admission control for the first flow and/or UE but does not have resources to admit the subsequent flows and/or UE(s) of the group, then the RAN may reserve resource for the first flow/UE, and respond to the SMF by indicating that the RAN can allocate resources for a single flow/UE only. In response to receiving this indication, the SMF and/or PCF can determine whether this single flow/UE resource reservation is acceptable and/or whether to instruct the RAN to release the resources reserved for the first flow/UE. To assist in this signalling, the following further discloses the use, by a RAN, of a new Next Generation Application Protocol (NGAP) cause code for communicating a success or failure action appropriately in relation to this. The determined instruction from the SMF and/or the PCF may be signalled to a RAN. Upon receipt of such signalling, the RAN may apply the received instruction.

Further, in the event that the RAN fails in admission control for a single flow/UE and/or group of UE(s), then the RAN may respond to the SMF indicating that the admission control failed completely.

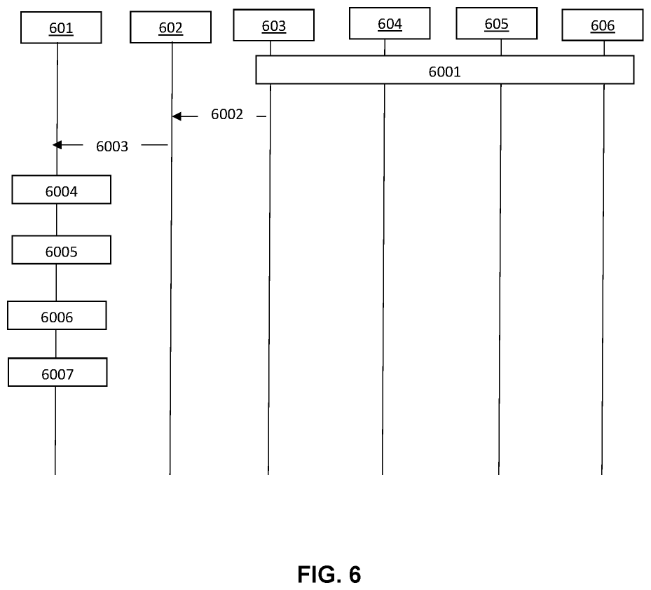

The presently described principles are described in more detail in reference to FIGS. 6 to 8. For clarity and brevity, the following uses only “total number of flows” in relation to these Figures. However, it is understood that this may be replaced by “total number of UEs” and/or “total number of flows and total number of UEs” without further modification to the presently described mechanism.

FIG. 6 illustrates signalling that may be performed between a RAN entity 601, an Access and Mobility Function (AMF) 602, a Session Management Function (SMF) 603, a Policy and Control Function (PCF) 604, a Network Exposure Function (NEF) 605, and an application function (AF) 605. Although not shown in FIG. 6, the RAN 601 may provide network access to at least a first UE, a second UE, and a third UE.

During 6001, the SMF 603, PCF 604, NEF 605, and AF 606 exchange signalling. This signalling of 6001 may relate to the AF sending a request to request joint handling of multiple UE(s)/traffic flows, the request comprising an indication of UEs and/or flows associated in the group. Which flows and/or UEs are associated together may be defined by the application function.

The NEF 605, on receiving this information from the AF 606 may interpret the request (by, for example, determine that a group policy is to be generated), and send an authorization request to the PCF 604 that comprises the flow group information. The authorization request may request that the PCF attach the flow group information to policy rules to generate a group policy.

In response to this authorization request, the PCF 604 may generate a group policy for the involved UE/traffic flows and sends the policies to the involved SMFs. The policies of the group policy may be preconfigured or dynamic. The policies of the group policy may be based on third party function decisions, local policies, and/or operator policies. The PCF 604 may further determine the total number of QoS flows (and/or total number of UEs) within the QoS flow group, and provide them to SMF 603 (and/or any other SMF 603 that may be involved in these session(s)). The SMF 603 may use this information to determine a QoS flow binding.

At the end of the signalling of 6001, the SMF 603 may comprise information relating to an identifier for the flow group being considered (i.e., a flow group ID), and a total number of flows that form part of this flow group.

During 6002, the SMF 603 signals the AMF 602. This signalling of 6002 may provide configuration information for the QoS flow group to the AMF 602. This signalling of 6002 may comprise the flow group ID and the total number of flows that form part of this flow group. The signalling of 6002 may comprise a request for Protocol Data Unit (PDU) session modification. The signalling of 6002 may comprise an Namf_Communication_N1N2MessageTransfer Application Program Identifier (API) service operation.

During 6003, the AMF 602 signals the RAN entity 601, This signalling of 6003 may comprise configuration information for the QoS flow group. This signalling of 6003 may comprise the flow group ID and the total number of flows that form part of this flow group. The signalling of 6003 may indicate first flow(s)/UE(s). In the present context, the phrase “first flow(s)/UE(s)” may relate to a subset (i.e., less than all) of the total number of flows of the flow group. These first flow(s)/UE(s) may be for first admittance by the RAN entity. The remaining flow(s)/UE(s) in the group (i.e., those flows in the flow group that are not part of the “first flow(s)/UE(s)) may be the subject of later signalling (e.g., later N2 signalling). The signalling of 6003 may comprise the request for Protocol Data Unit (PDU) session modification detailed above in relation to 6002. This signalling of 6003 may be comprised in an N2 message. An N2 message is a message signalled over an N2 interface. An N2 interface supports control plane signalling between RAN and 5G core covering scenarios related to UE context management, PDU session/resource management procedures. The N2 interface uses Stream Control Transmission Protocol (SCTP) between 5GCN and access network, and may use the NGAP protocol.

6004 to 6007 relate to an example operation in which, upon receiving the PDU session modification message of 6003 for a first UE in the flow group, the RAN entity 601 performs group admission control for the QoS flow group. In this example of FIG. 6, the RAN entity determines that the RAN entity is able to admit all the total number of QoS flows. The RAN entity may determine that the RAN entity is able to admit all the total number of QoS flows in the group by using the total number of flows information and the first flow(s)/UE(s) information.

During 6004, the RAN entity 601 configures resources in the user plane for the received flow information for the first UE.

During 6005, the RAN entity 601, determines that the RAN entity 601 can admit all the total number of QoS flows indicated in the signalling of 6003, and reserves resources for the remaining number of flows for which the RAN entity 601 has not yet received a PDU session modification request message in respect of.

During 6006, the RAN entity 601 starts a timer (or similar monitoring mechanism). This is because the resource reservation for other UE(s)/Flows may be performed for a period of time according to such a timer value. Therefore, after resource reservation, RAN node starts the timer. The initial value of such a timer (which defines the total duration of time measured by the timer) may be RAN-internal and/or implementation specific.

During 6007, the timer of 6006 expires. When the timer expires before the RAN entity 601 receives a PDU session modification message for at least some of the remaining flows, the RAN entity 601 releases the reserved resources in respect of those at least some remaining flows. In contrast, when at least one PDU session modification message for the remaining flows is received before the timer expiry, the RAN entity 601 configures resources in user plane based on the reserved resources.

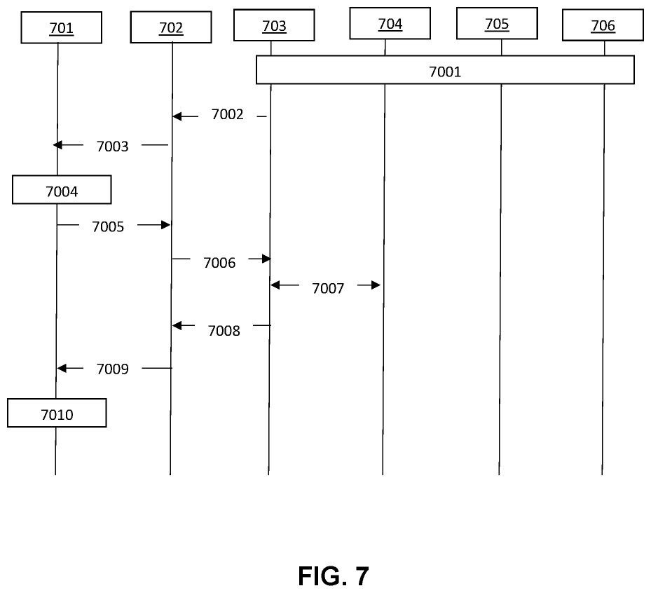

FIG. 7 illustrates another example mechanism. In this example of FIG. 7, upon receiving a first PDU session modification message within N2 message for the first UE, RAN performs group admission control for the QoS flow group. However, in contrast to the example of FIG. 6, in this example of FIG. 7, the RAN entity determines that the RAN entity is able to admit flows associated with the first user equipment, but not the flows associated with the remaining user equipments/flows.

FIG. 7 illustrates signalling that may be performed between a RAN entity 701, an Access and Mobility Function (AMF) 702, a Session Management Function (SMF) 703, a Policy and Control Function (PCF) 704, a Network Exposure Function (NEF) 705, and an application function (AF) 706. Although not shown in FIG. 7, the RAN 701 may provide network access to at least a first UE, a second UE, and a third UE.

During 7001, the SMF 703, PCF 704, NEF 705, and AF 706 exchange signalling. This signalling of 7001 may relate to the AF sending a request to request joint handling of multiple UE(s)/traffic flows, the request comprising an indication of UEs and/or flows associated in the group.

The NEF 705, on receiving this information from the AF 706 may interpret the request and send an authorization request to the PCF 704 that comprises the flow group information.

In response to this authorisation request, the PCF 704 may generate a group policy for the involved UE/traffic flows and sends the policies to the involved SMFs. The PCF 704 may further determine the total number of QoS flows (and/or total number of UEs) within the QoS flow group, and provide them to SMF 703 (and/or any other SMF 703 that may be involved in these session(s)). The SMF 703 may use this information to determine a QoS flow binding.

At the end of the signalling of 7001, the SMF 703 may comprise information relating to an identifier for the flow group being considered (i.e., a flow group ID), and a total number of flows that form part of this flow group.

During 7002, the SMF 703 signals the AMF 702. This signalling of 7002 may provide configuration information for the QoS flow group to the AMF 702. This signalling of 7002 may comprise the flow group ID and the total number of flows that form part of this flow group. The signalling of 7002 may comprise a request for Protocol Data Unit (PDU) session modification. The signalling of 7002 may comprise an Namf_Communication_N1N2MessageTransfer Application Program Identifier (API) service operation.

During 7003, the AMF 702 signals the RAN entity 701, This signalling of 7003 may comprise configuration information for the QoS flow group. This signalling of 7003 may comprise the flow group ID and the total number of flows that form part of this flow group. The signalling of 7003 may comprise the request for Protocol Data Unit (PDU) session modification detailed above in relation to 7002. This signalling of 7003 may be comprised in an N2 message.

7004 to 7010 relate to the example in which only the network entity 701 determines that it is only able to reserve resources in respect of a fraction of the total number of flows indicated in the signalling of 7003, where the fraction is less than 1.

During 7004, the RAN entity 701 reserves resources in respect of the flows associated with the first UE.

During 7005, the RAN entity signals the AMF 702. The signalling of 7005 may comprise an N2 message. The signalling of 7005 may be related to session management, and may indicate that the admission of all the flows indicated during 7003 is not possible. This indication may be provided by a new cause code (e.g., over NGAP).

This signalling of 7005 may comprise the flow group identifier, an indication that at least one flow in the flow group cannot be admitted, and an indication that at least one flow in the flow group may be admitted. A flow is considered to be admitted when the RAN entity 701 is able to reserve resources for that flow. The reserved resources may be data bearers for sending a traffic stream to the user of that flow. The signalling of 7005 may comprise any other information that can be useful for assisting a core network entity to determine a responsive action to this signalling.

During 7006, the AMF 702 signals the SMF 703. This signalling of 7005 may comprise the information discussed above in relation to the signalling of 7005. The signalling of 7006 may comprise an Nsmf_PDUSession_UpdateSMContext API service operation.

When the PCF 704 is subscribed to receive updates from SMF 703 in relation to this flow, 7007 is performed. During 7007, the SMF 703 and the PCF 704 exchange signalling. In this signalling, the SMF 703 notifies the PCF 704 that the RAN entity was unable to reserve resources in respect of all of the flows. The signalling of 7007 may comprise an Npcf_SMPolicyControl_Update service operation. The signalling of 7008 may comprise the information provided during 7007.

During the signalling of 7007, the SMF 703 and/or the PCF 704 may determine a corresponding action to be taken by the RAN entity 701 in view of the RAN entity's inability to reserve resources in respect of all of the flows. An example corresponding action is accepting the admission of only a subset of the flow group. Another example corresponding action is rejecting the admission of only a subset of the flow group by requesting a release of the currently reserved resources.

During 7008, the SMF 703 signals the AMF 702. This signalling of 7008 may comprise an indication of the corresponding action determined during 7007. This signalling of 7008 may comprise the flow group ID. The signalling of 7008 may comprise a PDU session modification message. The signalling of 7008 may comprise an Namf_Communication_N1N2MessageTransfer API service operation.

During 7009, the AMF 702 signals the RAN entity 701. This signalling of 7009 may comprise the information provided during 7008. The signalling of 7009 may comprise an N2 message.

During 7010, the RAN entity 701 applies the corresponding action indicated during 7009. For example, the RAN entity 701 may either release the reserved resources or configure the resources for the first user equipment. The RAN entity 701 may maintain reserved resources for the flows that can be admitted. In this case, 6006 and 6007 from FIG. 6 are performed.

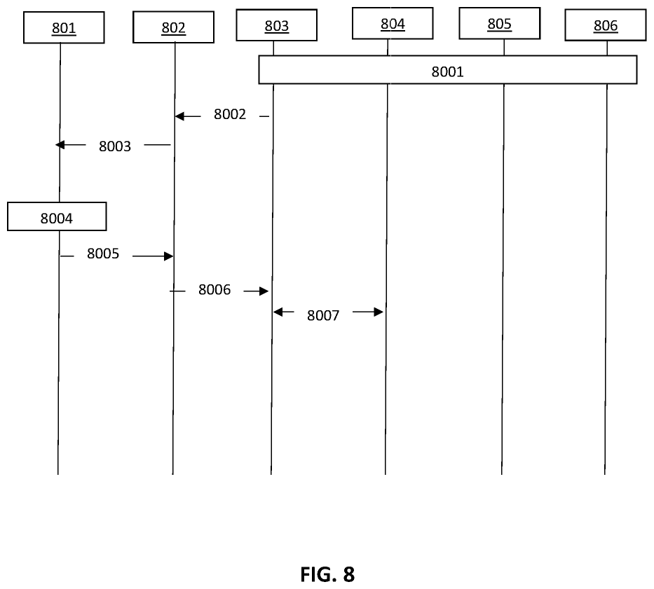

FIG. 8 illustrates another example mechanism. In this example of FIG. 8, upon receiving a first PDU session modification message within N2 message for the first UE, RAN performs group admission control for the QoS flow group. However, in contrast to the examples of FIGS. 6 and 7, in this example of FIG. 8, the RAN entity determines that the RAN entity is unable to admit any of the flows indicated in the group admission control request.

FIG. 8 illustrates signalling that may be performed between a RAN entity 801, an Access and Mobility Function (AMF) 802, a Session Management Function (SMF) 803, a Policy and Control Function (PCF) 804, a Network Exposure Function (NEF) 805, and an application function (AF) 806. Although not shown in FIG. 8, the RAN 801 may provide network access to at least a first UE, a second UE, and a third UE.

During 8001, the SMF 803, PCF 804, NEF 805, and AF 806 exchange signalling. This signalling of 8001 may relate to the AF sending a request to request joint handling of multiple UE(s)/traffic flows, the request comprising an indication of UEs and/or flows associated in the group.

The NEF 805, on receiving this information from the AF 806 may interpret the request and send an authorization request to the PCF 804 that comprises the flow group information.

In response to this authorisation request, the PCF 804 may generate a group policy for the involved UE/traffic flows and sends the policies to the involved SMFs. The PCF 804 may further determine the total number of QoS flows (and/or total number of UEs) within the QoS flow group, and provide them to SMF 803 (and/or any other SMF 803 that may be involved in these session(s)). The SMF 803 may use this information to determine a QoS flow binding.

At the end of the signalling of 8001, the SMF 803 may comprise information relating to an identifier for the flow group being considered (i.e., a flow group ID), and a total number of flows that form part of this flow group.

During 8002, the SMF 803 signals the AMF 802. This signalling of 8002 may provide configuration information for the QoS flow group to the AMF 802. This signalling of 8002 may comprise the flow group ID and the total number of flows that form part of this flow group. The signalling of 8002 may comprise a request for Protocol Data Unit (PDU) session modification. The signalling of 8002 may comprise an Namf_Communication_N1N2MessageTransfer Application Program Identifier (API) service operation.

During 8003, the AMF 802 signals the RAN entity 801, This signalling of 8003 may comprise configuration information for the QoS flow group. This signalling of 8003 may comprise the flow group ID and the total number of flows that form part of this flow group. The signalling of 8003 may comprise the request for Protocol Data Unit (PDU) session modification detailed above in relation to 8002. This signalling of 8003 may be comprised in an N2 message.

8004 to 8007 relate to the example in which only the RAN entity 801 determines that the RAN entity is unable to admit any of the flows indicated in the group admission control request.

During 8004, the RAN entity 801 determines that it is unable to admit the first user equipment's flows. This means that the RAN entity 801 does not reserve any resources in respect of the first user equipment's flows.

During 8005, the RAN entity 801 signals the AMF 802. During this signalling of 8009, the RAN entity 801 indicates that the RAN entity 801 is unable to reserve any resources in respect of the whole flow group identifier by the flow group identifier. The signalling of 8005 may comprise the flow group identifier. The signalling of 8005 may comprise an explicit indication that the whole flow group could not be admitted. The signalling of 8005 may comprise an N2 message.

During 8006, the AMF 802 signals the SMF 803. This signalling of 8006 may inform the SMF that the RAN entity 801 was unable to admit the whole flow group. For example, this signalling of 8006 may comprise the information indicated in respect of 8005. The signalling of 8006 may comprise an Nsmf_PDUSession_UpdateSMContext API service operation.

During 8007, the SMF 803 signals the PCF 804. This signalling of 8007 may inform the PCF that the RAN entity 801 was unable to admit the whole flow group. For example, this signalling of 8007 may comprise the information of 8006. This signalling of 8007 may comprise an Npcf_SMPolicyControl_Notify service operation. 8007 may be performed only when the PCF 804 has subscribed to receive this information from the SMF 803.

In all of the above examples of FIGS. 6 to 8, it is understood that the information comprised in any of the above signalling received by a core network entity (e.g., an SMF and/or a PCF) may be signalled to the AF via an NEF.

It is understood that although the present disclosure is framed in terms of an extended reality (XR) service, that the present principles may be applied to any application/service that utilises joint treatment of multiple flows, such as in Industrial Internet of Things (IIoT) applications.

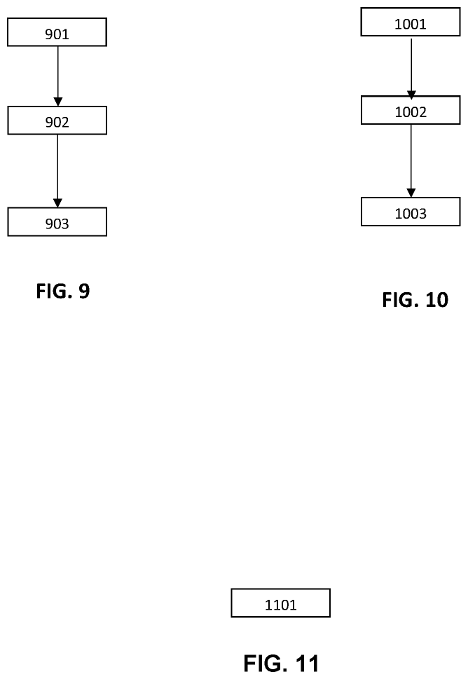

FIGS. 9 to 11 illustrate example operations that may be performed by apparatus described herein, and highlight aspects of the above examples. It is therefore understood that features described above may find correspondence in these example operations, and may provide more specific examples of how these may be implemented.

FIG. 9 illustrates operations that may be performed by a radio access network entity. The radio access network entity/RAN apparatus may be a control plane entity that facilitates admission procedures between a core network and a user equipment.

During 901, the RAN entity receives, from a network function, an indication of a first number of data flows and/or of user equipment whose communications are to be jointly handled, an identifier of said first number of data flows that are to be jointly handled, an indicator that joint handling is to be performed for the first number of data flows and/or of user equipment, and a subset of said first number of data flows and/or user equipment for which resources are to be configured. The subset may be identified, or otherwise indicated in the signalling of 901.

During 902, the RAN entity determines whether the radio access network entity is able to reserve enough resources for jointly handling at least said subset of said first number of data flows and/or of user equipment.

During 903, the RAN entity signals a result of said determination to the network function.

The result of said determination may be that resources can be reserved in respect of all of said first number of data flows and/or user equipment. In this case, the RAN entity may: configure a first portion of said resources that are comprised in said subset; reserve a second portion of said resources in respect of all of the data flows and/or user equipment of said first number data flows and/or user equipment that are not comprised in said subset; starting a timer when reserving said second portion of said resources; and release any of said reserved resources that have not been configured at a user equipment at an expiry of said timer.

The result of said determination may be that resources can be reserved in respect of only the subset. In this case, the RAN entity may: reserve said resources in respect of at least the subset of the said subset of data flows and/or user equipment.

The RAN entity may: start a timer when reserving said resources; and release any of said reserved resources that have not been configured at a user equipment at an expiry of said timer.

The RAN entity may, subsequent to said signalling the network function: receive, from the network function, an instruction to release said reserved resources; and release said reserved resources in response to receiving said instruction.

The result of said determination may be that no resources may be reserved in respect of any of said data flows and/or user equipment. In this case, RAN entity may abstain from reserving and/or configuring resources in respect of any of these data flows and/or user equipment.

FIG. 10 illustrates operations that may be performed by a first network function. The first network function may be the network function mentioned above in relation to FIG. 9. Therefore, the apparatus of FIG. 10 may interact with the apparatus of FIG. 9 via signalling.

During 1001, the first network function receives, from a second network function, a first indication of a first number of data flows and/or of user equipment whose communications are to be jointly handled, an identifier of said first number of data flows that are to be jointly handled, an indicator that joint handling is to be performed for the first number of data flows and/or of user equipment, and a subset of said first number of data flows and/or user equipment for which resources are to be configured.

During 1002, the first network function signals said first indication to at least one of a radio access network entity and/or a third network function.

During 1003, the first network function receives, from the at least one of a radio access network entity and/or a third network function, a second indication of whether the radio access network entity is able to reserve enough resources for jointly handling at least the said subset.

The second network function may be at least one of: an application function; a network exposure function; a policy control function; and/or a session management function.

The first network function may be at least one of: a network exposure function; a policy control function; a session management function; and/or an access and mobility function.

The third network function may be at least one of: a policy control function; a session management function; an access and mobility function, and/or an application function.

The second indication may indicate that resources are configured in respect of a subset of said data flow(s) and/or user equipment and can be reserved in respect of a remaining subset of said data flows and/or user equipment of the first set, the method comprising signalling said second indication to the second network function.

The second indication may indicate that resources can be reserved in respect of a subset of said data flows and/or user equipment. In this case, the first network function may signal said second indication to the second network function.

The first network function may signal, to the at least one of a radio access network entity and/or a third network function, an instruction to configure the reserved resources for at least the subset and/or all of the data flows and/or user equipment of said first number data flows and/or user equipment that are not comprised in said subset.

The first network function may signal, to the at least one of a radio access network entity and/or a third network function, an instruction to release said reserved resources.

The second indication may indicate that resources cannot be reserved in respect of any of said data flows and/or user equipment, the method comprising signalling said second indication to the second network function.

FIG. 11 illustrates operations that may be performed by an application function. The application function may be the second network function mentioned in relation to FIG. 10, and may therefore interact with the first network function of FIG. 10 (in some examples).

During 1101, the application function signals, to a first network function, an indication of a first number of data flows and/or of user equipment whose communications are to be jointly handled, an identifier of said first number of data flows that are to be jointly handled, an indicator that joint handling is to be performed for the first number of data flows and/or of user equipment, and said first number of data flows and/or user equipment for which resources are to be configured.

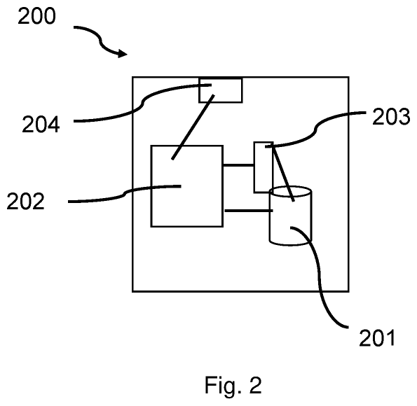

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions.

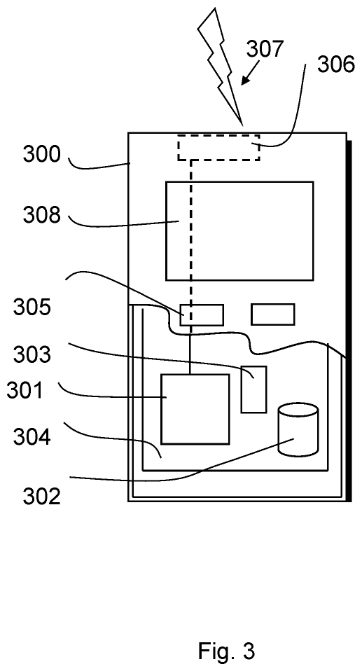

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or’ wireless) to other devices and/or for connecting external accessories, for example hands-free equipment, thereto.

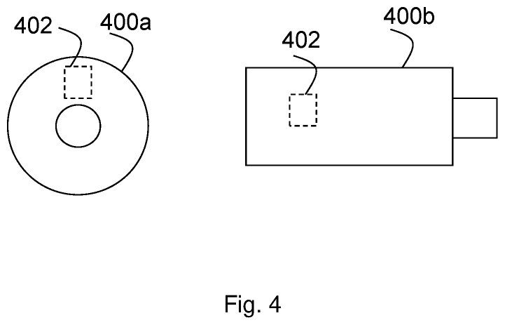

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 9, and/or FIG. 10 and/or FIG. 11, and/or methods otherwise described previously.

As provided herein, various aspects are described in the detailed description of examples and in the claims. In general, some examples may be implemented in hardware or special purpose circuits, software, logic or any combination thereof. For example, some aspects may be implemented in hardware, while other aspects may be implemented in firmware or software which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures, e.g., as in FIG. 9, and/or FIG. 10 and/or FIG. 11, and/or otherwise described previously, may represent program steps, or interconnected logic circuits, blocks and functions, or a combination of program steps and logic circuits, blocks and functions. The software may be stored on such physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (AStudy ItemC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuits (such as analogue and/or digital circuit);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of the term “means” in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

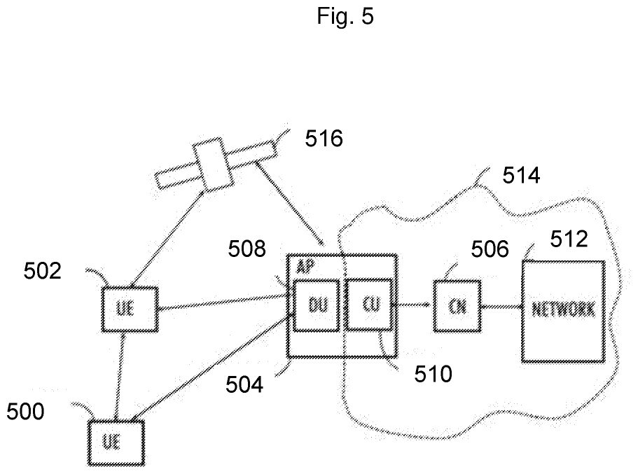

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support sidelink communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g)NodeB serving devices in a cell. In one example, the node 504 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 506 (CN or next generation core NGC). Depending on the deployed technology, the (e/g)NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHZ, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz—cmWave, 6 or above 24 GHz—cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The LTE network architecture is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). This may also be referred to as Edge computing when performed away from the core network. The communication system may also comprise a central control entity, or a like, providing facilities for networks of different operators to cooperate for example in spectrum sharing.

The technology of Edge computing may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where Edge computing servers can be placed between the core and the base station or nodeB (gNB). One example of Edge computing is MEC, which is defined by the European Telecommunications Standards Institute. It should be appreciated that MEC (and other Edge computing protocols) can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service for critical availability communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. At least one of the (e/g)NodeBs or may be a Home(e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 5 may provide any kind of these cells. A cellular radio system may be implemented as a multilayer network including several kinds of cells. Typically, in multilayer networks, one access node.

1. A radio access network entity, the comprising:
at least one processor;
at least one memory comprising computer code, which when executed by the at least one processor, cause the radio access network entity to perform operations, the operations comprising:
receiving, from a network function, indication of a first number of data flows that form part of a flow group and/or of user equipment whose communications are to be jointly handled, an identifier of said flow group of said data flows that are to be jointly handled, an indicator that joint handling is to be performed for the data flows of said flow group and/or of user equipment, and an indication of a subset of data flows of said flow group and/or user equipment for which resources are to be configured;
determining whether the radio access network entity is able to reserve sufficient resources for jointly handling at least said subset of data flows and/or of user equipment; and
signalling a result of said determination to the network function.

2. The method as claimed in claim 1, wherein the result of said determination is that resources can be reserved in respect of all of said data flows that form part of said flow group and/or user equipment, and wherein the operations further comprise:
configuring a first portion of said resources for the data flows that are comprised in said subset of data flows and/or user equipment;
reserving a second portion of said resources for data in respect of all of the data flows comprised in said flow group and/or user equipment and/or user equipment that are not comprised in said subset;
starting a timer when reserving said second portion of said resources; and
releasing any of said reserved resources that have not been configured at a user equipment at an expiry of said timer.

3. The apparatus as claimed in claim 1, wherein the result of said determination is that resources can be reserved in respect of only the subset of data flows, and wherein the operations further comprise:
reserving said resources in respect of at least the subset of data flows and/or user equipment.

4. The apparatus as claimed in claim 3, wherein the operations further comprise:
starting a timer when reserving said resources; and
releasing any of said reserved resources that have not been configured at a user equipment at an expiry of said timer.

5. The apparatus as claimed in claim 4, wherein the operations further comprise, subsequent to said signalling the network function:
receiving, from the network function, an instruction to release said reserved resources; and
releasing said reserved resources in response to receiving said instruction.

6. The apparatus as claimed in claim 1, wherein the result of said determination is that no resources may be reserved in respect of any of said data flows of said flow group and/or user equipment.

7. An apparatus for a communication system, the apparatus comprising:
at least one processor;
at least one memory comprising computer code which, when executed by the at least one processor, cause the radio access network entity to perform operations, the operations comprising:
receiving, from a second network function, a first indication of a first number of data flows that form part of a flow group and/or of user equipment whose communications are to be jointly handled, an identifier of said flow group of said data flows that are to be jointly handled, an indicator that joint handling is to be performed for the data flows of said flow group and/or of user equipment, and a subset of data flows of said flow group and/or user equipment for which resources are to be configured;
signalling said first indication to at least one of a radio access network entity a or a third network function; and
receiving, from the at least one of the radio access network entity or the third network function, a second indication of whether the radio access network entity is able to reserve enough resources for jointly handling at least the said subset of data flows.

8. The apparatus as claimed in claim 7, wherein the first network function is a network exposure function, and the second network function is one of: an application function; a policy control function; or a session management function.

9. The apparatus as claimed in claim 7, wherein the first network function is a policy control function, and the second network function is one of: an application function; a network exposure function, or a session management function.

10. The apparatus as claimed in claim 7, wherein the third network function is at least one of: a policy control function; a session management function; an access and mobility function, and/or an application function.

11. The apparatus as claimed in claim 7, wherein the second indication indicates that resources are configured in respect of the subset of said data flows and/or user equipment and can be reserved in respect of a remaining subset of said data flows of said flow group and/or user equipment, the method comprising signalling said second indication to the second network function.

12. The apparatus as claimed in claim 7, wherein the second indication indicates that resources can be reserved in respect of a subset of said data flows, and wherein the operations further comprise signalling said second indication to the second network function.

13. The apparatus as claimed in claim 12, wherein the operations further comprise signalling, to the at least one of the radio access network entity or the third network function, an instruction to configure the reserved resources for at least the subset or all of the data flows of said first number data flows that are not comprised in said subset.

14. The apparatus as claimed in claim 12, wherein the operations further comprise signalling, to the at least one of the radio access network entity or the third network function, an instruction to release said reserved resources.

15. The apparatus as claimed in claim 7, wherein the second indication indicates that resources cannot be reserved in respect of any of said data flows of said flow group, and wherein the operations further comprise signalling said second indication to the second network function.

16-23. (canceled)

24. The apparatus as claimed in claim 7, wherein the first network function is a session management function, and the second network function is one of: an application function; a network exposure function; or a policy control function.

25. The apparatus as claimed in claim 7, wherein the first network function is an access and mobility function, and the second network function is one of: an application function; a network exposure function; a policy control function, or a session management function.
